(19) United States
(12) Patent Application Publication
(10) Pub. No.: US 2021/0021637 A1
(43) Pub. Date: Jan. 21, 2021

(54) METHOD AND SYSTEM FOR DETECTING AND MITIGATING NETWORK BREACHES

(71) Applicant: Kumar Srivastava, Mountain View, CA (US)

(72) Inventor: Kumar Srivastava, Mountain View, CA (US)

(21) Appl. No.: 16/512,317

(22) Filed: Jul. 15, 2019

(51) Int. Cl. H04L 29/06

(52) U.S. Cl. CPC H04L 63/1483; H04L 63/1416; H04L 63/1425; H04L 63/105; H04L 63/102; H04L 63/0876

(57) ABSTRACT

Disclosed is a method and a system for detecting and managing phishing attack. The security product of the present invention enables a user to look at the activity of any other user and all of their owned devices before and after a phishing attack targeted at that user. The present invention also enables the user to look at the activity of the infrastructure and determine if an attack has occurred and what is the impact of that attack. The present invention also enables the user to view various attacks on their infrastructure.

### FIELD OF THE INVENTION

The present invention relates generally to artificial intelligence (AI), and, more particularly, to a method and a system for detecting and mitigating network breaches.

### BACKGROUND

The importance of information security threat identification, analysis, management, and prevention has grown dramatically in recent years and continues to expand. For example, with the increasing use of the Internet and electronic communication, such as e-mail, for business, personal, and entertainment purposes, efficient, safe, accurate, and reliable electronic communication is essential. Without such communications, tremendous economic and other damage can result, and the utility of electronic communication is compromised. Effectively identifying, analyzing, and managing threats to information security is therefore critical.

Spam, piracy, hacking, phishing, and virus spreading, for example, represent important and growing threats. Unsolicited bulk e-mails, or “UBEs”, can cause serious loss in many ways. In the business context, one type of UBE, unsolicited email (UCE or “spam”) is distracting, annoying, wastes workers' time, and reduces productivity. It can clog or slow down networks, and spread computer viruses and pornography, leading to further complications and losses. Excessive UBEs may lead to workers disregarding actual solicited e-mail.

In a phishing attack, an individual (e.g., a person, an employee of a company, an individual of a computing device) receives a message, commonly in the form of an e-mail, directing the individual to perform an action, such as opening an e-mail attachment or following (e.g., using a cursor controlled device or touch screen) an embedded link. If such message were from a trusted source (e.g., co-worker, bank, utility company), such action might carry little risk. Nevertheless, in a phishing attack, such message is from an attacker (e.g., an individual using a computing device to perform an malicious act on another computer device user) disguised as a trusted source, and an unsuspecting individual, for example, opening an attachment to view a “friend's photograph” might in fact install malicious computer software (i.e., spyware, a virus, and/or other malware) on his/her computer. Similarly, an unsuspecting individual directed (e.g., directed via an embedded link in an e-mail) to a webpage made to look like an authentic login or authentication webpage might be deceived into submitting (e.g., via a web form) his/her username, password or other sensitive information to an attacker.

While there are computer programs designed to detect and block phishing emails, phishing attacks methods are constantly being modified by attackers to evade such forms of detection. The present invention addresses some shortcoming of previous attempts to counter phishing attacks.

### BRIEF SUMMARY

It is an objective of the present invention to provide a method and a system for detecting and managing phishing attack. The security product of the present invention has the following objectives. In one embodiment, the present invention enables a user to look at the activity of any other user and all of their owned devices before and after a phishing attack targeted at that user
a. Monitor phishing email
b. Monitor click stream
c. Is user clicking on phishing or suspicious URLs?
d. Post clicking, is user (or device or their IPs)
   i. Accessing files they did not access before
   ii. Accessing DB data they did not access before (queries)
   iii. Sending emails that they did not send before
   iv. Access pattern (frequency, volume, query type) different than before.

Further, the present invention enables the user to look at the activity of the infrastructure and determine if an attack has occurred and what is the impact of that attack a. View outbound data egress—network activity
b. View billing distribution and volume change
c. View increase in compute activity
d. View increase in log volume and log types including errors
e. View security accounts created
f. View roles upgraded and downgraded
g. Compute instances created
h. App Engine jobs created/started
i. View changes by aggregate, network zones, instance types, security account type, labels.

Further, the present invention enables the user to view various attacks on their infrastructure
a. Invalid user login attempts
b. Scanning activity
c. SQL injection attempts
d. Sshd login attempts
e. Su logs
f. DB logs
   i. Query log:
   ii. Query error:
   iii. Authentication error:
g. Firewall Logs
i. Allow/Deny.

Further, the present invention enables the user to view coordinated attacks where users belonging to the same team or working on the same projects or using similar devices are targeted at the same time as a campaign
a. Similarities between users targeted by a campaign
b. Similarities between phishing emails targeting various users
c. Similarities between attacks impacting the same device
d. Similarities between attacks impacting the same resources (Data, compute, network).

These and other features and advantages of the present invention will become apparent from the detailed description below, in light of the accompanying drawings.

### BRIEF DESCRIPTION OF THE ACCOMPANYING DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIG. 1 is a block diagram that illustrates a system environment in which various embodiments of the present invention are practiced;

FIGS. 2A and 2B show an exemplary block diagram for illustrating high level workflow, in accordance with an embodiment of the present invention; and

FIG. 3 is a block diagram that illustrates a system architecture of a computer system for detecting and managing phishing attack, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes methods and systems for detecting and managing network breaches from phishing attack. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

While various exemplary embodiments of the disclosed systems and methods have been described below, it should be understood that they have been presented for purposes of example only, and not limitations. It is not exhaustive and does not limit the invention to the precise form disclosed. Modifications and variations are possible in light of the above teachings or may be acquired from practicing of the invention, without departing from the breadth or scope.

The present invention will now be described with reference to the accompanying drawings, which should be regarded as merely illustrative without restricting the scope and ambit of the present invention.

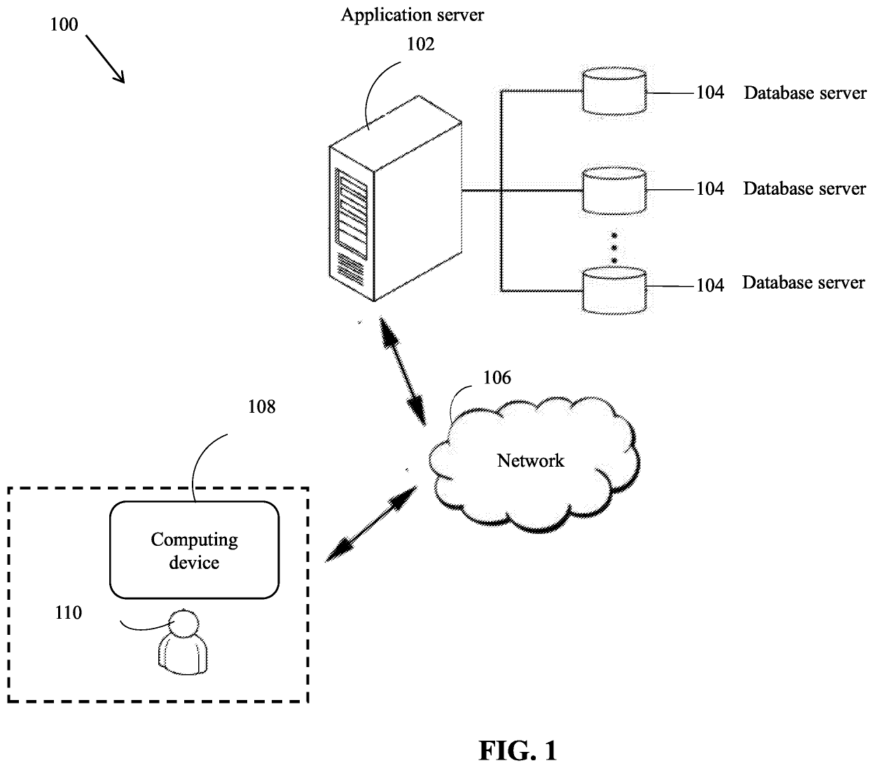

FIG. 1 is a block diagram that illustrates a system environment 100 in which various embodiments of the present invention are practiced. The system environment 100 includes an application server 102, one or more database servers such as a database server 104, and a network 106. The system environment 100 further includes one or more user computing devices associated with one or more users such as a user computing device 108 associated with a user 110. The application server 102 and the user computing device 108 may communicate with each other over a communication network such as the network 106. The application server 102 and the database server 104 may also communicate with each other over the same network 106 or a different network.

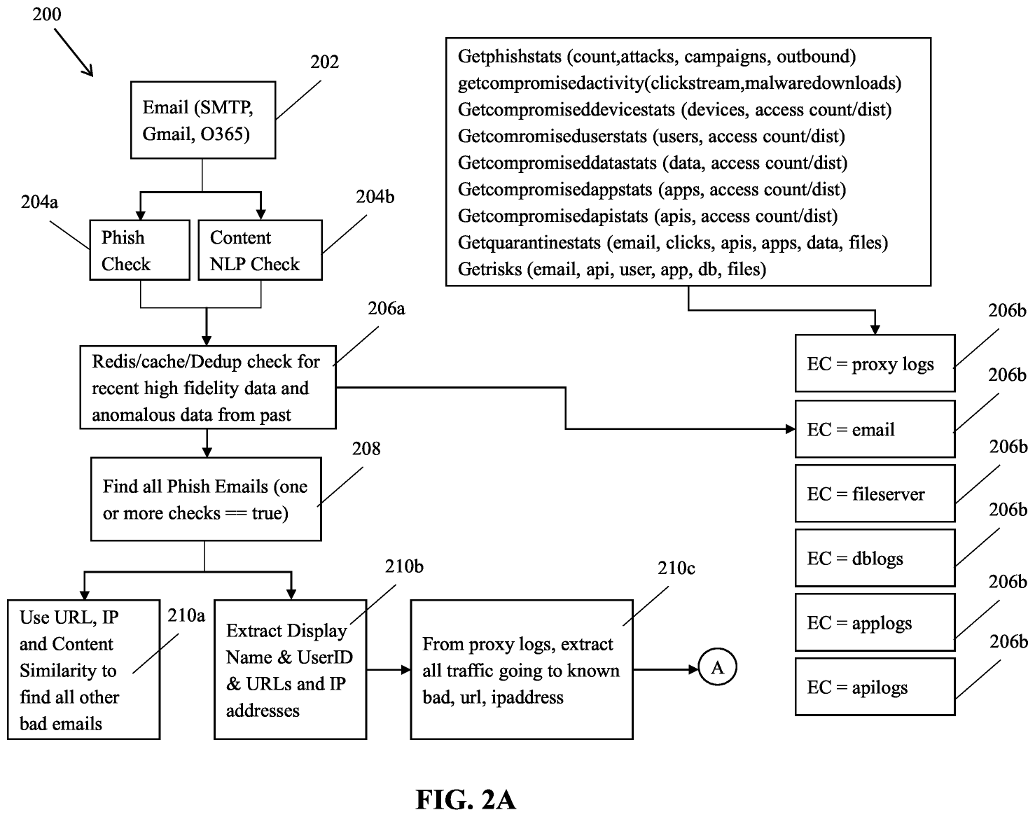

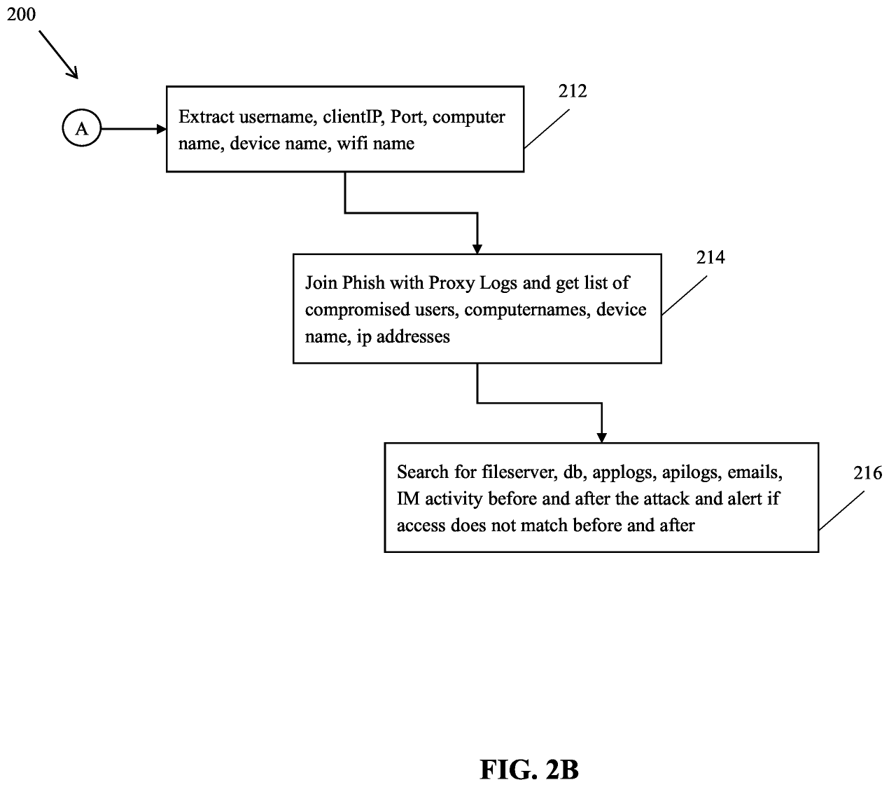

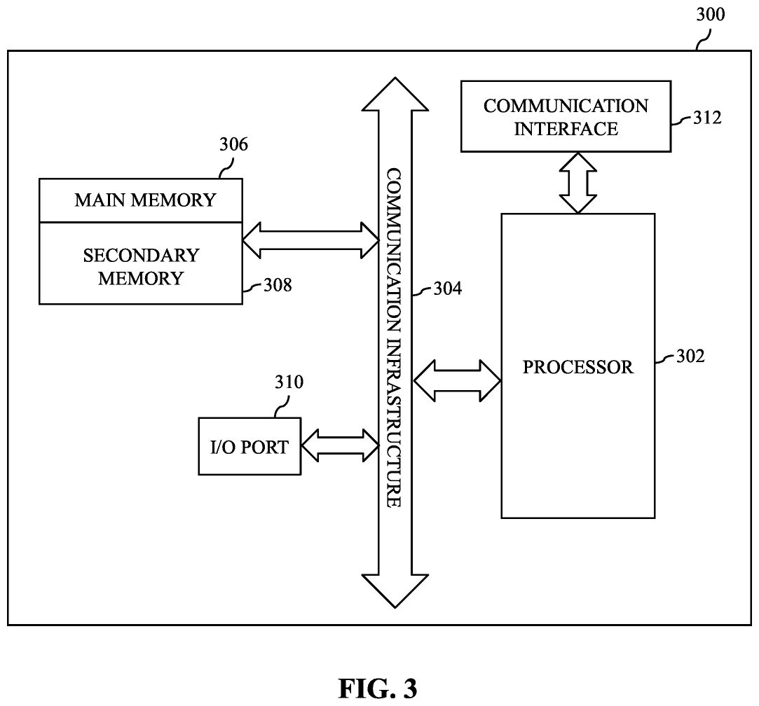

The application server 102 is a computing device, a software framework, or a combination thereof, that may provide a generalized approach to create the application server implementation. Various operations of the application server 102 may be dedicated to execution of procedures, such as, but are not limited to, programs, routines, or scripts stored in one or more memory units for supporting its applied applications and performing defined operations. For example, the application server 102 is configured to identify incoming email as phish using a phish check library. The application server 102 is further configured to extract malicious URLs or downloads. The application server 102 is further configured to detect other emails that might also be phished. The application server 102 is further configured to detect outbound phish activity and identify user/computer/IP as infected. The application server 102 is further configured to use the user/computer/IP as key to look in outbound access logs to look for clicking of malicious URLs or download of malicious software. The application server 102 is further configured to model a user fingerprint of the user 110. The application server 102 is further configured to look for external or internal IP traffic. The application server 102 is further configured to look for Ip address activity inbound and outbound. The application server 102 is further configured to run all access logs and syslogs through security engine and extract all risks. The application server 102 is further configured to extract all users, devices, IP addresses and names from the risks. The application server 102 is further configured to monitor internal network activity through syslog and look for user/device/IP address behavior. The application server 102 is further configured to build fingerprinting and behavior anomaly and profiles. The application server 102 also enables the user 110 to look at the activity of any other user and all of their owned devices before and after a phishing attack targeted at that user 110. The application server 102 also enables the user 110 to look at the activity of the infrastructure and determine if an attack has occurred and what is the impact of that attack. The application server 102 also enables the user 110 to view various attacks on their infrastructure. The application server 102 also enables the user 110 to view coordinated attacks where users belonging to the same team or working on the same projects or using similar devices are targeted at the same time as a campaign. Various other operations of the application server 102 have been described in detail in conjunction with FIGS. 2A, 2B, and 3.

Examples of the application server 102 include, but are not limited to, a personal computer, a laptop, or a network of computer systems. The application server 102 may be realized through various web-based technologies such as, but not limited to, a Java web-framework, a .NET framework, a PHP (Hypertext Preprocessor) framework, or any other web-application framework. The application server 102 may operate on one or more operating systems such as Windows, Android, Unix, Ubuntu, Mac OS, or the like.

The database server 104 may include suitable logic, circuitry, interfaces, and/or code, executable by the circuitry that may be configured to perform one or more data management and storage operations such as receiving, storing, processing, and transmitting queries, data, or content. In an embodiment, the database server 104 may be a data management and storage computing device that is communicatively coupled to the application server 102 or the user computing device 108 via the network 106 to perform the one or more operations.

In an exemplary embodiment, the database server 104 may be configured to manage and store “risky” or “suspicious” data (communication, content and activity) in optimized storage and ML optimized data structures. In an exemplary embodiment, the database server 104 may be configured to manage and store recent emails.

In an embodiment, the database server 104 may be configured to receive a query from the application server 102 for retrieval of the stored information. Based on the received query, the database server 104 may be configured to communicate the requested information to the application server 102. Examples of the database server 104 may include, but are not limited to, a personal computer, a laptop, or a network of computer systems.

The network 106 may include suitable logic, circuitry, interfaces, and/or code, executable by the circuitry that may be configured to transmit messages and requests between various entities, such as the application server 102, the database server 104, and the user computing device 108. Examples of the network 106 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the system environment 100 may connect to the network 106 in accordance with various wired and wireless communication protocols, such as Transmission Control Protocol and Internet Protocol (TCP/IP), User Datagram Protocol (UDP), Long Term Evolution (LTE) communication protocols, or any combination thereof.

FIGS. 2A and 2B show an exemplary block diagram 200 for illustrating high level workflow, in accordance with an embodiment of the present invention. Firstly, the application server 102 connects to one or more email servers, for example, as shown at step 202. Thereafter, the application server 102 performs phish checks, for example, as shown at steps 204a and 204b. Thereafter, the application server 102 store recent emails in a cache, for example, as shown at steps 206a and 206b. Thereafter, the application server 102 finds other similar recent emails on the cache (such as the database 104). At step 208, the applications server 102 finds all phish emails by performing one or more checks. Thereafter, the application server 102 build a list of users under attack, bad URLs, bad IPs or ranges. At step 210a, the application server 102 uses URL, IP and Content Similarity to find all other bad emails. At step 210b, the application server 102 extracts display name & user ID & URLs and IP addresses. At step 210c, the application server 102, from proxy logs, extracts all traffic going to known bad URL or IP address. Further, the application server 102 looks for proxy logs that contain requests to bad URLs or IPs. Make list of users, clientip, port, device and wi-fi being used. At step 212, the application server 102 extracts username, client IP, port, computer name, device name, wi-fi name. At step 214, join phish with proxy logs and get list of compromised users, computer names, device name, IP addresses, or the like. At 216, search for fileserver, db, applogs, apilogs, emails, IM activity before and after the attack and alert if access does not match before and after.

FIG. 3 is a block diagram that illustrates a system architecture of a computer system 300 for detecting and managing phishing attack, in accordance with an embodiment of the present invention.

An embodiment of the present invention, or portions thereof, may be implemented as computer readable code on the computer system 300. In one example, the application server 102 of FIG. 1 may be implemented in the computer system 300 using hardware, software, firmware, non-transitory computer readable media having instructions stored thereon, or a combination thereof and may be implemented in one or more computer systems or other processing systems. Hardware, software, or any combination thereof may embody modules and components used to implement the various operations illustrated in the present invention. The computer system 300 includes a processor 302 that may be a special purpose or a general-purpose processing device. The processor 302 may be a single processor, multiple processors, or combinations thereof. The processor 302 may have one or more processor “cores.” Further, the processor 302 may be connected to a communication infrastructure 304, such as a bus, a bridge, a message queue, the network 106, multi-core message-passing scheme, and the like. The computer system 300 further includes a main memory 306 and a secondary memory 308. Examples of the main memory 306 may include RAM, ROM, and the like. The secondary memory 308 may include a hard disk drive or a removable storage drive (not shown), such as a floppy disk drive, a magnetic tape drive, a compact disk, an optical disk drive, a flash memory, and the like. Further, the removable storage drive may read from and/or write to a removable storage device in a manner known in the art. In an embodiment, the removable storage unit may be a non-transitory computer readable recording media. The computer system 300 further includes an input/output (I/O) port 310 and a communication interface 312. The I/O port 310 includes various input and output devices that are configured to communicate with the processor 302. Examples of the input devices may include a keyboard, a mouse, a joystick, a touchscreen, a microphone, and the like. Examples of the output devices may include a display screen, a speaker, headphones, and the like. The communication interface 312 may be configured to allow data to be transferred between the computer system 300 and various devices that are communicatively coupled to the computer system 300. Examples of the communication interface 312 may include a modem, a network interface, i.e., an Ethernet card, a communications port, and the like. Data transferred via the communication interface 312 may be signals, such as electronic, electromagnetic, optical, or other signals as will be apparent to a person skilled in the art. The signals may travel via a communications channel, such as the network 106, which may be configured to transmit the signals to the various devices that are communicatively coupled to the computer system 300. Examples of the communication channel may include, but not limited to, cable, fiber optics, a phone line, a cellular phone link, a radio frequency link, a wireless link, and the like. Computer program medium and computer usable medium may refer to memories, such as the main memory 306 and the secondary memory 308, which may be a semiconductor memory such as dynamic RAMs. These computer program mediums may provide data that enables the computer system 300 to implement the present invention. In an embodiment, the present invention is implemented using a computer implemented application. The computer implemented application may be stored in a computer program product and loaded into the computer system 300 using the removable storage drive or the hard disk drive in the secondary memory 308, the I/O port 310, or the communication interface 312.

Workflow

In an embodiment, the application server 102 may be configured to identify one or more incoming emails. The one or more emails may be identified as Phish using a phish check library. Further, the application server 102 may be configured to predict or extract “call to action” i.e., one or more texts near a link or button or filename of the attachments.

In an embodiment, the application server 102 may be configured to perform social engineering attack prediction and phish sandbox. In such a scenario, the application server 102 may analyze the content and call to action using machine learning (ML). Further, the application server 102 may detect one or more attempts to phish and social engineering attack to a user (such as the user 110). The application server 102 may further detect potentially direct or indirect monetary attack. The application server 102 may further execute URL in the phish sandbox with fake credentials/workflow and convert into profile to watch using phish credential generation service.

In an embodiment, the application server 102 may be configured to extract malicious URLs or downloads. The application server 102 may be further configured to detect other emails that might also be phish (using similarity) and identify one or more users/computers/IPs as infected. The application server 102 may be further configured to detect outbound phish activity and identify the one or more users/computers/IPs as infected. The application server 102 may be further configured to use the one or more users/computers/IPs as key to look (or search) into one or more outbound access logs. The one or more outbound access logs may be looked or searched to identify for clicking of malicious URLs or download of malicious software.

In an embodiment, the application server 102 may be configured to model or generate a user fingerprint for the user (such as the user 110). The user fingerprint may be modeled or generated based on one or more sites (visited by the user) including site classification (type, known, or unknown), and also including “frequency”, “duration gap”, “size of request”, “size of response”.

In an embodiment, the application server 102 may be configured to identify the one or more users/computers/IPs as infected based on the one or more URL clicks or download activities. The application server 102 may be further configured to identify other similar users/computers/IPs as infected and name as “At Risk Watchlist”.

In an embodiment, the application server 102 may be further configured to look or search for external IP traffic. The application server 102 may use one or more techniques including user agent, frequency, gap duration, http version, http requests or types, download, upload, query strings in the one or more URLs, one or more POST contents, excessive request length, excessive response length, non-standard PORTs, non-standard http methods, and URLs/Queries to look or search for the external IP traffic. The application server 102 may maintain one or more counters for each of the above.

In an embodiment, the application server 102 may be configured to look for internal IP—external IP connections properties and detect if it is “bad” or not. In a scenario where it is bad, the application server 102 may be further configured to find similar bad internal IP—external IP tuples. The application server 102 may be further configured to calculate and maintain a tuple counter, and one or more metrics are updated every time any tuple is observed including “Frequency”, “Gap between connections”, “Size of connections”, HTTP Version, HTTP Methods, PORTS, Request Length, and Response Length.

In an embodiment, the application server 102 may be further configured to look for external IPs that are known bad and look for other external IPs that are being accessed by internal IPs also accessing the known bad external IPs. The application server 102 may be further configured to look for other external IPs that are similar to bad IPs.

In an embodiment, the application server 102 may be further configured to look for IP address activity inbound and outbound and identify at least one of (a) low variance external activity, (b) high frequency, low duration (short lived, periodic probes or attacks), (c) low frequency, similar duration, (d) historically suspicious but dormant, and (e) auto tiering and auto classification of raw data, for example, (i) selectively and automatically tag incoming data (emails, web activity, network activity, API activity, database activity) with severity (using ML and historical definitions of “normal” and predefined rules) and (ii) store “risky” or “suspicious” data (communication, content, and activity) in optimized storage and ML optimized data structures (such as the database server 104).

In an embodiment, the application server 102 may be further configured to run all access logs and syslogs through security engine and extract all risks. The application server 102 may be further configured to extract all users, devices, IP addresses, and names from the risks. The application server 102 may be further configured to monitor internal network activity through syslog and look for the user/device/IP address behavior. For example, the application server 102 may look for the number of access to highly valuable, PII data, the number of actions with root or admin privileges, the number of actions tampering/deleting/editing access logs or syslogs, the number of instances of multiple access events or logon events in a short period of time, the number of actions of using identification and authentication mechanisms, the number of actions where privileges are elevated, the number of edit/deletions to account info using root/admin access, the number of actions where logs are initialized or stopped or paused, and the number of actions where system level objects such as database tables or stored procedures are created/deleted.

In an embodiment, the application server 102 may be further configured to build fingerprinting & behavior anomaly profiles. The fingerprinting & behavior anomaly profiles may be build using:
a. Fingerprints based on user-machines-roles tuples
b. What (websites, network services, data)
c. How (frequency, gap between connection, duration of connection)
d. Target (all data or subset, all files or subset)
e. Establish the user/device/computer/Wi-Fi/IP address fingerprint
   i. Time Unit, Application ID, Proces sID, MessagelD
   ii. Time Unit, URL, Activity (get, put, post, option etc.)
   iii. Time Unit, DB, DB String, DB Query
   iv. Time Unit, API, Activity
f. Generate behavior fingerprint before and after the phish attack
g. Generate profiles of the user/device/computer/Wi-Fi/IP address to establish forecastable behavior profiles
h. Include elements of
   i. What data is accessed
      1. High value or low value
   ii. What is the extent of the data access
      1. All or partly, raw or analytical
   iii. When is the data accessed
      1. Periodically, office hours, randomly
   iv. How is the data accessed
      1. Application or Direct, Manual or automated
   v. Who
      1. User context or system or process
i. Fingerprints are adaptive and are updated only if there is a change in the activity but the user is not on the “At risk watchlist”
j. Alert if the behavior changes. Change defined by an “aggressiveness” value that can be configured
   i. New applications seen
   ii. New processes seen
   iii. New messages seen
   iv. New API/Method combinations seen
   v. New DB queries seen
   vi. New connecting IPs

In an embodiment, the application server 102 may be further configured to perform tuple behavior anomaly detection. The application server 120 may be configured to execute appropriate algorithms or instructions stored in its memory to perform the tuple behavior anomaly detection. The application server 102 may implement or execute various anomaly detection techniques to perform the tuple behavior anomaly detection. For example, the various anomaly detection techniques includes, but are not limited to, (a.) top and bottom percentiles, (b.) outside standard deviation of average behavior of similar tuples, (c.) deviation from profile based on historical profile of the tuple, (d.) deviation from profile based on historical profile of the first entity in the tuple across all activity with all second entities, and (e.) deviation from profile based on historical profile of the second entity in the tuple across all activity with all first entities.

In an embodiment, the application server 102 may be further configured to perform the tiered access determination. The tiered access determination may be performed by autocorrelating timeseries of access to high value and low value data and/or autocorrelating timeseries of access to high value and uploading of high value data.

In an embodiment, the application server 102 may be further configured to perform predictive quarantining. If the user/device/computer/Wi-Fi/IP address is determined to be anomalous, one or more quarantining activities may be issued. For example, the access may be blocked. The credentials may be revoked. The credentials may be refreshed. The re-authorization may be requested. The access may be throttled. Also, the application server 102 may be further configured to perform predictive sandboxing where a device, laptop, or server is sandboxed and may not allow to access any other part of the network. No traffic is allowed to go into that device and access is also not allowed.

In an embodiment, the application server 102 may be further configured to perform user attack propagation determination with event generation. The application server 102 may determine whether the attack has started, whether the attack has completed, and the data/service loss. In an embodiment, the application server 102 may be further configured to perform predictive rerouting. For example, if a user is likely phished, his communication is automatically rerouted through a deep proxy that can generate fake data and pretend to service the request while invoking a second review and out of band notification. In another example, if a user is about to get phished, reroute them to a proxy. Let proxy make a call to phish URL, download what the phish URL is asking, analyze and decide to warn the user again or let it go. Execute URL in sandbox with fake credentials/workflow and convert into profile to watch using phish credential generation service.

In an embodiment, other additional features to capture in fingerprinting are may include: (1) Multidimensional Tupling—The application server 102 may look at the data and transform it into tuples that capture activity and relationship between two entities. For each tuple, the application server 102 may create multiple metrics such as IP Address—IP Address, IP Address—URL, IP Address—Host, IP Address—Application, IP Address—Service, IP Address—Access, Hostname—IP Address, Hostname—URL, Hostname—Hostname, Hostname—Application, Hostname—Service, User—IP Address, User—Hostname, User—URL, User—Application, IP, Address—Login, IP Address—FileAccess, IP Address—SQL, IP Address—URL, IP Address—Service, Hostname—Login, Hostname—FileAccess, Hostname—SQL, Hostname—Service, Hostname—URL, Hostname—Access, User—Login, User—FileAccess, User—SQL, User—Service, User—Access, User—Vulnerability, IP Address—Vulnerability, and Hostname—Vulnerability, (2) Tuple Graph driven extended fingerprinting including sequence-enhanced fingerprints. Here, using the defined tuples and external data, the application server 102 may build a graph of the following entities (IP address, Hostname, URL, User, Applications, Service, Logins, FileAccess, SQL, Service). These graphs are used to establish relationships and for generating extended relationships and behavior including the sequence of activities that involve connected entities in any given time window or in a defined grouping such as geo-centricity, organizational centricity and other such schemes to define and categorize, (3) Cross Tuple Behavior Model. Here, the application server 102 may build a behavior model of every entity across tuples. The application server 102 may also build behavior model of similar entities or related entities, and (4) Predictive Behavior including
Predictive Quarantining—the application server 102 disables ability of an entity to communicate, contact or access assets
Predictive Sandboxing—the application server 102 disables ability of an entity to log in, startup, or access network and systems

Predictive Access Correction—the application server 102 reduces or removes ability of entity to access previously accessible assets
Predictive Re-routing—the application server 102 redirects traffic, requests, communication, content and activity through secure channel to a proxy for further analysis and policy action
Predictive Credentials Lifecycle Management
Predictive Policy Enforcement
Predictive High Stakes action Approval & double verify
Predictive TTL and Exponential Slowdown
Predictive Network Fencing

In an embodiment, the application server 102 may be further configured to generate extensible tuple sets. The application server 102 may execute appropriate algorithms or instructions stored in its memory to expand to new tuple definitions of any type including entity-to-entity (e.g., IP-IP), entity-to-action (e.g., IP-login), or entity-to-behavior (e.g., IP-excessive logins), and define fingerprints for the tuples and build tuple behavior profiles as timeseries.

In an embodiment, the application server 102 may be further configured to perform extensible, auto activity categorization. The application server 102 may execute appropriate algorithms or instructions stored in its memory to perform the categorization. The application server 102 is able to automatically categorize various activities into various categories using categorization techniques such as topic modeling. The application server 102 generates a semantic layer that describes the activity. The application server 102 also has the ability to apply additional layers of semantic understanding. The additional layers of semantic understanding may be applied by combining categories with other categories to generate super categories. The application server 102 further automatically determines an appropriate level of categorization hierarchy based on the signal content of each generated layer i.e., whether a generated layer contains a good distribution across the categorical values.

In an embodiment, the application server 102 may be further configured to perform predictive mitigation. For example, the application server 102 may perform the predictive quarantining by disabling ability of an entity to communicate, contact, or access assets based on prediction of compromise. The application server 102 may perform predictive sandboxing by, disabling ability of an entity to log in, startup, or access network and systems based on prediction of compromise. The application server 102 may perform predictive access correction by reducing or removing ability of entity to access previously accessible assets based on prediction of compromise. The application server 102 may perform predictive re-routing by redirecting traffic, requests, communication, content and activity through secure channel to a proxy for further analysis and policy action based on prediction of compromise. The application server 102 may perform predictive credentials lifecycle management including upgrade, downgrading, reassessing, reviewing, creation and deletion of credentials based on prediction of compromise. The application server 102 may perform predictive policy enforcement including policy management & governance based on prediction of compromise. The application server 102 may perform predictive high stakes action approval & double verification based on prediction of compromise. The application server 102 may perform predictive time to live and exponential slowdown for entities accessing data, services, compute on the network based on prediction of compromise. The application server 102 may perform predictive network & geo fencing & time fencing to limit access to data, services, compute to a certain geo region or network/subnetwork or time window of entities based on prediction of compromise.

In an embodiment, the key APIs includes:
(1) Email (getphishstats)
   Number of phishing emails received
   Number of current phish attacks (an attack is defined more than 1 person receiving same/similar email)
   Number of campaigns (different emails with same phish URLs or same malware file attachment)
(2) Clicks & Downloads (getcompromisedactivity)
   Number of Phish URLs clicked
   Number of malware downloaded
(3) Data (getcompromiseddatasets)
   Number of Datasets compromised
(4) Users (Getcompromisedusers)
   Number of users attacked
   Number of users phished
   Number of users with malware
   Number of Identified Potential Attack Targets
(5) Devices (getcompromiseddevices)
   Number of compromised devices
(6) APIs (getcompromisedapis)
   Number of APIs under attack
(7) Apps (getcompromisedapps)
   Number of Apps under attack
(8) Predictive Quarantine (getquarantines)
   Number of outbound emails blocked
   Number of data access blocked
   Number of API access blocked
   Number of app access blocked
   Number of Devices blocked
   Number of requests rerouted
(9) Risks (getrisks)
   List of all users under risk including summary of activity/behavior
   List of all apps under risk including summary of activity/behavior
   List of all devices under risk including summary of activity/behavior
   List of all data sets under risk including summary of activity/behavior
   List of all APIs under risk including summary of activity/behavior
   Number of users under risk
   Number of Apps under risk
   Number of Devices under risk
   Number of Datasets under risk
   Number of APIs under risk

In an embodiment, the real-time recommendations may include identification and reporting of (1) Users similar to ones that are being attacked, (2) Emails similar to the ones found as phish (both incoming & outgoing), (3) Users similar to ones who clicked on phish or downloaded malware, and (4) Users and similar users (and IPs, hostnames) who are exhibiting compromised activity.

In an embodiment, the security product disclosed in the present invention facilitates various objectives. For example, the security product of the present invention:
1. Enables a user to look at the activity of any other user and all of their owned devices before and after a phishing attack targeted at that user
   a. Monitor phishing email
   b. Monitor click stream
   c. Is the user clicking on phishing or suspicious URLs?
   d. Post clicking, is the user (or device or their IPs)
      i. Accessing files he did not access before
      ii. Accessing DB data he did not access before (queries)
      iii. Sending emails that he did not send before
      iv. Access pattern (frequency, volume, query type) different than before
2. Enables the user to look at the activity of the infrastructure and determine if an attack has occurred and what the impact of that attack has been
   a. View outbound data egress—network activity
   b. View billing distribution and volume change
   c. View increase in compute activity
   d. View increase in log volume and log types including errors
   e. View security accounts created
   f. View roles upgraded and downgraded
   g. Compute instances created
   h. App Engine jobs created/started
   i. View changes by aggregate, network zones, instance types, security account type, or labels
3. Enables the user to view various attacks on their infrastructure
   a. Invalid user login attempts
   b. Scanning activity
   c. SQL injection attempts
   d. Sshd login attempts
   e. Su logs
   f. DB logs
      i. Query log:
      ii. Query error:
      iii. Authentication error:
   g. Firewall Logs
      i. Allow/Deny
4. Enables the user to view coordinated attacks where users belonging to the same team or working on the same projects or using similar devices are targeted at the same time as a campaign
   a. Similarities between users targeted by a campaign
   b. Similarities between phishing emails targeting various users
   c. Similarities between attacks impacting the same device
   d. Similarities between attacks impacting the same resources (Data, compute, network).

Although particular embodiments of the invention have been described in detail for purposes of illustration, various modifications and enhancements may be made without departing from the spirit and scope of the invention.

What is claimed is:

1. A system, comprising:
circuitry configured to:
identify an incoming email as phish using a phish check library;
extract malicious URLs (Uniform Resource Locators) or downloads;
detect other emails that are phish using similarity, and identify user/computer/IP as infected;
detect outbound phish activity and identify the user/computer/IP as infected;
use the user/computer/IP as key to look in outbound access logs to look for clicking of malicious URLs or download of malicious software;
generate user fingerprint for determining possibility of a phish attack, wherein
when a user is likely phished, a communication is automatically rerouted through a deep proxy that can generate fake data and pretend to service a request while invoking a second review and out of band notification, or
when the user is about to get phished, reroute them to a proxy that makes a call to phish URL, download what the phish URL is asking, analyze and decide to warn user again.

2. The system of claim 1, wherein the circuitry is further configured to generate the user fingerprint based on user-machines-roles tuples.

3. The system of claim 1, wherein the circuitry is further configured to establish user/device/computer/wi-fi/IP address fingerprint, and generate behavior fingerprint before and after the phish attack.

4. The system of claim 1, wherein the circuitry is further configured to update the fingerprint when there is change in activity only if the user is not at risk.

5. The system of claim 1, wherein the circuitry is further configured to:
enable the user to look at the activity of any other user and all of their owned devices before and after a phishing attack targeted at that user,
enable the user to look at the activity of infrastructure and determine if a phishing attack has occurred,
enable the user to view various attacks on its infrastructure, and
enable the user to view coordinated attacks where users belonging to the same team or working on the same projects or using similar devices are targeted at the same time as a campaign.

6. The system of claim 1, wherein the circuitry is further configured to determine external IP traffic by using techniques including user agent, frequency, gap duration, http version, http requests/types, download, upload, query strings in URL, POST contents, excessive request length, excessive response length, non-standard PORTs, non-standard http methods, URLs/Queries, and maintains counter for each.

7. The system of claim 6, wherein the circuitry is further configured to look for internal IP—external IP connections properties and detect if “bad” and find similar bad internal IP—External IP tuples.

8. The system of claim 1, wherein the circuitry is further configured to generate the user fingerprint by using multidimensional tupling, in which data is transformed into tuples that capture activity and relationship between two entities, wherein multiple metrics are created for each tuple.

9. The system of claim 8, wherein the circuitry is further configured to generate the user fingerprint by using tuple graph driven extended fingerprinting including sequence-enhanced fingerprints.

10. The system of claim 9, wherein the circuitry is further configured to generate the user fingerprint by using cross tuple behavior model or predictive behavior.

11. The system of claim 1, wherein the circuitry is further configured to perform predictive quarantining by disabling ability of an entity to communicate, contact, or access assets based on prediction of compromise.

12. The system of claim 1, wherein the circuitry is further configured to perform predictive sandboxing by disabling ability of an entity to log in, startup, or access network based on prediction of compromise.

13. The system of claim 1, wherein the circuitry is further configured to perform predictive access correction by reducing or removing ability of an entity to access previously accessible assets based on prediction of compromise.

14. The system of claim 1, wherein the circuitry is further configured to perform predictive re-routing by redirecting traffic, requests, communication, content, and activity through secure channel to a proxy for further analysis and policy action based on prediction of compromise.

15. The system of claim 1, wherein the circuitry is further configured to perform predictive credentials lifecycle management including upgrade, downgrading, reassessing, reviewing, creation and deletion of credentials based on prediction of compromise.

16. The system of claim 1, wherein the circuitry is further configured to perform predictive policy enforcement including policy management and governance based on prediction of compromise.

17. The system of claim 1, wherein the circuitry is further configured to perform, based prediction of compromise:
predictive high stakes action approval nd double verification,
predictive time to live and exponential slowdown for entities accessing data, services, compute on the network, or
predictive network and geo fencing and tip e fencing to limit access to data, services, compute to a certain geo region or network subnetwork or time window of entities.

18. The system of claim 1, wherein the circuitry is further configured to generate extensible tuple sets of any type including entity-to-entity, entity-to-action, or entity-to-behavior, and define fingerprints for tuples and build tuple behavior profiles as timeseries.

19. The system of claim 1, wherein the circuitry is further configured to perform tuple behavior anomaly detection by executing various anomaly detection techniques.

20. The system of claim 1, wherein the circuitry is further configured to automatically categorize activities into one or more categories by executing various categorization techniques, wherein an appropriate level of categorization hierarchy is automatically determined based on signal content of each generated layer.
